(19) United States
(12) Patent Application Publication
(10) Pub. No.: US 2016/0202395 A1
(43) Pub. Date: Jul. 14, 2016

(54) DISPLAY APPARATUS WITH IMPROVED VIEWING ANGLE

(71) Applicant: SAMSUNG DISPLAY CO., LTD., YONGIN-SI (KR)

(72) Inventors: JIWON LEE, SUWON-SI (KR); JOONGHYUN KIM, ASAN-SI (KR); JUYOUN SON, HWASEONG-SI (KR); SANGHO HWANG, SUWON-SI (KR)

(21) Appl. No.: 14/950,185

(22) Filed: Nov. 24, 2015

(30) Foreign Application Priority Data
Jan. 14, 2015 (KR) 10- 2015-0007051

(51) Int. Cl. G02B 5/02; G02F 1/1335

(52) U.S. Cl. CPC G02B 5/0247; G02F 1/133504; G02F 1/133602

(57) ABSTRACT

Provided is a display apparatus including a display panel and an optical film. The optical film includes a refraction layer including a first pattern in which a first air gap is defined, and an adhesive layer disposed between the refraction layer and the display panel, including first and second layers. The first layer is disposed between the second layer and the refraction layer, and the second layer is disposed between the first layer and the display panel, the second layer including a second pattern in which a second air gap is defined.

### CROSS-REFERENCE TO RELATED APPLICATIONS

This U.S. non-provisional patent application claims priority under 35 U.S.C. §119 of Korean Patent Application No. 10-2015-0007051, filed on Jan. 14, 2014, the entire contents of which are hereby incorporated by reference.

### TECHNICAL FIELD

The present disclosure herein relates to a display apparatus, and more particularly, to a display apparatus with improved display quality.

### DISCUSSION OF RELATED ART

A display apparatus may include any one of a liquid crystal display panel, an electro wetting display panel, an electrophoretic display panel, a micro electro mechanical system display panel, and an organic light emitting display panel.

In general, the display apparatus may have a viewing angle at which image quality characteristics of the display are maintained. When a viewer watches a display outside of the viewing angle, luminance may be reduced or color coordinate of the image may become wrong. Accordingly, a display apparatus having minimal changes in image quality outside of a viewing angle is desired.

### SUMMARY

The present disclosure provides a display apparatus with improved display quality.

Embodiments of the inventive concept provide display apparatuses including: a display panel displaying an image and an optical film disposed on the display panel. The optical film includes: a refraction layer including a first pattern in which a first air gap is defined and an adhesive layer disposed between the refraction layer and the display panel, attaching the refraction layer to the display panel, and including first and second layers. The first layer is disposed between the second layer and the refraction layer, and the second layer is disposed between the first layer and the display panel, the second layer including a second pattern in which a second air gap is defined.

A surface of the second layer, which is attached to the display panel, is defined as a first surface. The second pattern may be defined on the first surface and have a groove shape recessed from the first surface.

The second pattern may include a first concave groove extending in a first direction and a second concave groove which extends in a second direction crossing the first direction and intersects with the first concave groove.

The first pattern may have a width greater than that of the second pattern.

The second pattern may have a dot shape on a plane.

The first pattern may have a width greater than a diameter of the second pattern.

The second pattern may include a net pattern defined by a first concave groove extending in a first direction and a second concave groove extending in a second direction that intersects with the first direction, and a dot pattern having a dot shape.

The second layer may include a central area defined at the center of a plane and a boundary area surrounding the central area. The second pattern is defined in the central area.

The refraction layer may have hardness greater than that of the adhesive layer.

A surface of the refraction layer, which is attached to the adhesive layer, is defined as a second surface. The first pattern may be defined on the second surface and have a groove shape recessed from the second surface.

The a plurality of first patterns are provided, the plurality of first patterns may include a first concave pattern, a second concave pattern that is adjacent to the first concave pattern, a third concave pattern that is adjacent to the first concave pattern, wherein the first concave pattern is disposed between the second concave pattern and the third concave pattern, a distance between the first concave pattern and the second concave pattern is greater than a distance between the first concave pattern and the third concave pattern.

The optical film further may include a cover layer disposed on the refraction layer and covering the refraction layer.

The display apparatus may further include a backlight unit disposed below the display panel and providing the display panel with light.

In other embodiments of the inventive concept, display apparatuses include a display panel displaying an image, and an optical film disposed on the display panel, wherein the optical film includes: a refraction layer including a plurality of patterns in which air gaps are defined; an adhesive layer disposed below the refraction layer and attaching the refraction layer to the display panel; and a cover layer disposed above the refraction layer and covering the refraction layer, wherein the plurality of patterns include a first concave pattern, a second concave pattern that is adjacent to the first concave pattern, a third concave pattern that is adjacent to the first concave pattern, wherein the first concave pattern is disposed between the second concave pattern and the third concave pattern, a distance between the first concave pattern and the second concave pattern is greater than a distance between the first concave pattern and the third concave pattern

In other embodiments, a display apparatuses may include a display panel, a refraction layer including a first pattern, and an adhesive layer. The adhesive layer may include a second pattern, a top surface and a bottom surface. The refraction layer and the first pattern have a different refractive index. The refraction layer may be attached to the top surface of the adhesive layer and the display panel may be attached to the bottom surface of the adhesive layer. The adhesive layer may be deformed prior to the refraction layer when a pressure is applied to the display apparatus.

The adhesive layer may have a greater hardness than the refraction layer.

The width of the first pattern is greater than the width of the second pattern.

The second pattern may include a net pattern and a dot pattern. The net pattern includes a first concave groove extending in a first direction and a second concave groove extending in a second direction. The dot pattern has a dot shape.

A plurality of first patterns are recessed from a surface of the refraction layer, the plurality of first patterns may include a first concave pattern, a second concave pattern that is adjacent to the first concave pattern and a third concave pattern that is adjacent to the first concave pattern. The first concave pattern is disposed between the second concave pattern and the third concave pattern, a distance between the first concave pattern and the second concave pattern is greater than a distance between the first concave pattern and the third concave pattern.

The first pattern may have one of various polygonal shapes, the polygonal shape may be one of a prism, triangular pyramid, and quadrangular pyramid shapes.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an exploded perspective view of a display apparatus according to an embodiment of the inventive concept;

FIG. 2 is a plan view illustrating one side of an optical film in FIG. 1;

FIG. 3 is a cross sectional view taken along line I-I′ of FIG. 2;

FIG. 4 is a state view illustrating a state in which a pressure is applied to the optical film in FIG. 3;

FIG. 5 is a state view illustrating a state in which the optical film in FIG. 3 is attached on the display panel in FIG. 1;

FIG. 6 is a plan view of an optical film according to an embodiment of the inventive concept;

FIG. 7 is a cross sectional view of an optical film taken along line II-II′ of FIG. 6;

FIG. 8 is a cross sectional view of an optical film according to an embodiment of the inventive concept; and

FIG. 9 is a plan view of an optical film according to an embodiment of the inventive concept.

### DETAILED DESCRIPTION

Hereinafter, exemplary embodiments will be described in detail with reference to the accompanying drawings. The objects, characteristics and effects of the inventive concept will become apparent with the detailed descriptions of the preferred embodiment and the illustrations of related drawings as follows. The invention may, however, be embodied in many different forms and should not be construed as being limited to the embodiments set forth herein. Rather, these embodiments are provided so that this disclosure will be thorough and complete, and will fully convey the scope of the inventive concept to those skilled in the art. Accordingly, the scope of the inventive concept should not be construed as being limited to following embodiments set forth herein. In the following embodiments and drawings, like reference numerals in the drawings denote like elements.

It will be understood that although the terms first and second are used herein to describe various elements, these elements should not be limited by these terms. In the following description, it will be understood that when a layer (or film) is referred to as being ‘on’ another layer or substrate, it can be directly on the other layer or substrate, or intervening layers may also be present.

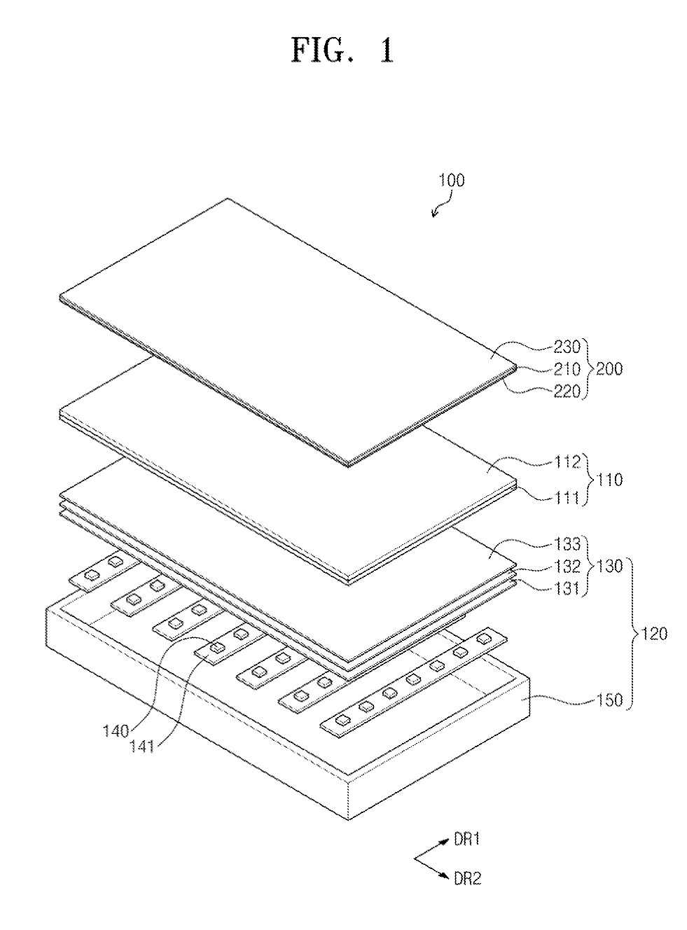

FIG. 1 is an exploded perspective view of a display apparatus according to an embodiment of the inventive concept.

Referring to FIG. 1, a display apparatus 100 may include a display panel 110 and an optical film 200.

The display panel 110 displays an image. The display panel 110 may be any one of a liquid crystal display panel, an electro wetting display panel, an electrophoretic display panel, a micro electro mechanical system display, and an organic light emitting display panel. The liquid crystal display panel will be used as an example in this embodiment, but is not limited thereto.

When the display panel 110 is a liquid display panel, the display apparatus 100 may further include a backlight unit 120 providing the display panel 110 with light.

The display panel 110 may have a rectangular plate shape having two pairs of sides. The display panel 110 may be a rectangle having a pair of long sides and a pair of short sides. The display panel 110 includes a lower substrate 111, an upper substrate 112 facing the lower substrate 111, and a liquid crystal layer (not shown) disposed between the lower substrate 111 and the upper substrate 112. When viewed from the top, the display panel 110 may include a display area in which an image is displayed, and a non-display area which surrounds the display area and in which an image is not displayed.

A plurality of pixels may be disposed in a matrix shape on the lower substrate 111 and each of the pixels may include a gate line (not shown) extending in a first direction, a data line (not shown) extending in a second direction to insulatively intersect with the gate line, and a pixel electrode (not shown). Also, a thin film transistor (not shown) may be disposed in each of the pixels and connected to the gate line, the data line, and the pixel electrode.

RGB (Red, Green, and Blue) pixels (not shown) that are color pixels and a common electrode (not shown) facing the pixel electrode may be disposed on the upper substrate 112. In an embodiment, the color pixel and the common electrode may be disposed on the lower substrate 111. The liquid crystal layer may be arranged according to the size of electric field formed between the pixel electrode and the common electrode to adjust the transmittance of light provided from the backlight unit 120, displaying desired gray scales.

The backlight unit 120 provides the display panel 110 with light and is disposed below the display panel 110. The backlight unit 120 may include optical sheets 130, a light source 140, and an accommodation part 150.

The optical sheets 130 may be disposed between the light source 140 and the display panel 110. The optical sheets 130 may control a path of light emitted from the light source 140. The optical sheets 130 may include a diffusion sheet 131, a prism sheet 132, and a protection sheet 133.

The diffusion sheet 131 may diffuse light and the prism sheet 132 may concentrate light such that a progress direction of the light diffused by the diffusion sheet 131 becomes close to a normal direction of the display panel 110. The protection sheet 133 may protect the prism sheet 132 from external shock. It is illustrated that the optical sheets 130 include one piece of diffusion sheet 131, one piece of the prism sheet 132, and one piece of the protection sheet 133, but are not limited thereto. For example, in an embodiment of the inventive concept, the optical sheets 130 may be used such that multiple pieces of at least one among the diffusion sheet 131, the prism sheet 132, and the protection sheet 133 are laminated. Alternatively, at least one of the sheets may not be provided.

The light source 140 may emit light toward the display panel 110. The light source 140 may be mounted on a printed circuit board 141 to receive a driving voltage from the printed circuit board 141. Alternatively, in an embodiment of the inventive concept, the backlight unit 120 may further include a light guide plate (not shown) disposed between the accommodation part 150 and the optical sheets 130, and the light source 140 may be disposed at a side of the light guide plate to emit light toward the light guide plate.

The accommodation part 150 may accommodate the light source 140, the optical sheets 130 and the accommodation part 150 supporting the display panel 110. In an embodiment of the inventive concept, a top chassis covering a non-display area of the display panel 110 and the accommodation part 150 coupled to the top chassis may be further provided. Also, in an embodiment of the inventive concept, a middle frame supporting the display panel 110 and the optical sheets 130 may be provided.

The optical film 200 may extend an angle at which image quality characteristics of an image displayed in the display panel 110 are maintained. For example, image quality characteristics may be defined by luminance, color coordinates, or the like. The luminance may represent an amount of incoming light which passes through a certain area, and the color coordinates may represent color and chroma but not the brightness of the image. Color includes three attributes color, brightness, and chroma. When a user watches an image in an area out of a range of a viewing angle, the luminance of the image may be reduced, and a color of the image may be seen differently when compared to the color seen within the range of the viewing angle. Accordingly, the optical film 200 may extend the viewing angle to increase a viewable area within which a user may watch the image.

The optical film 200 may include a refraction layer 210, an adhesive layer 220, and a cover layer 230.

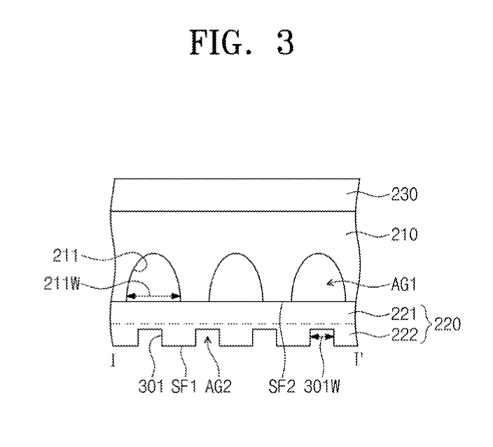

The refraction layer 210 may include a resin having a refractive index of one or more. The refraction layer 210 may include a first pattern (211 of FIG. 3). The first pattern (211 of FIG. 3) may refract and diffuse light passing through the refraction layer 210 by using a difference of the refractive index, enhancing the viewing angle of an image.

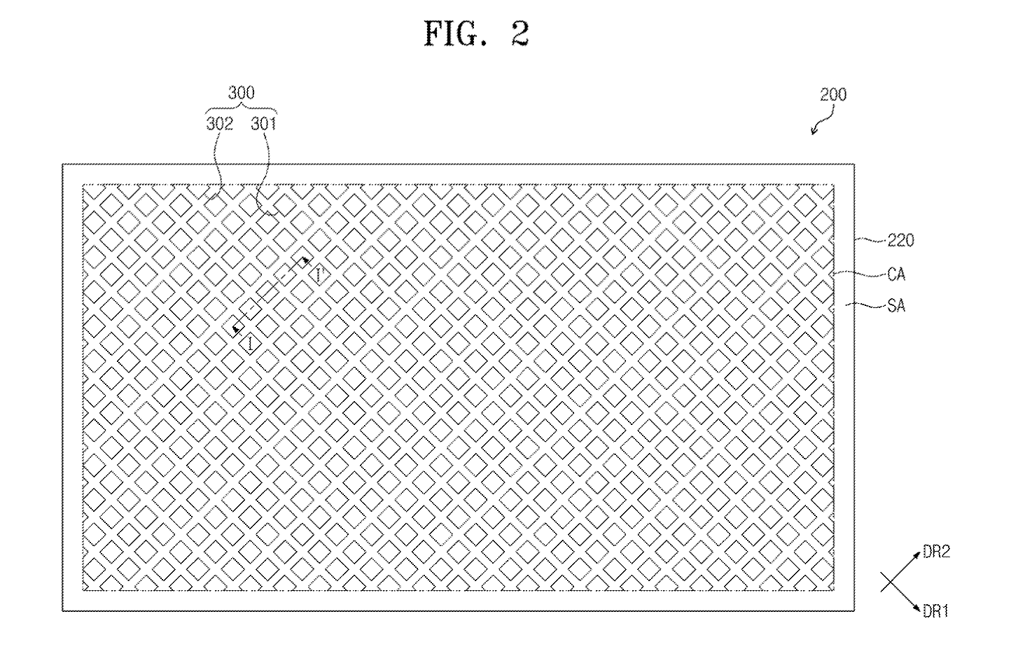

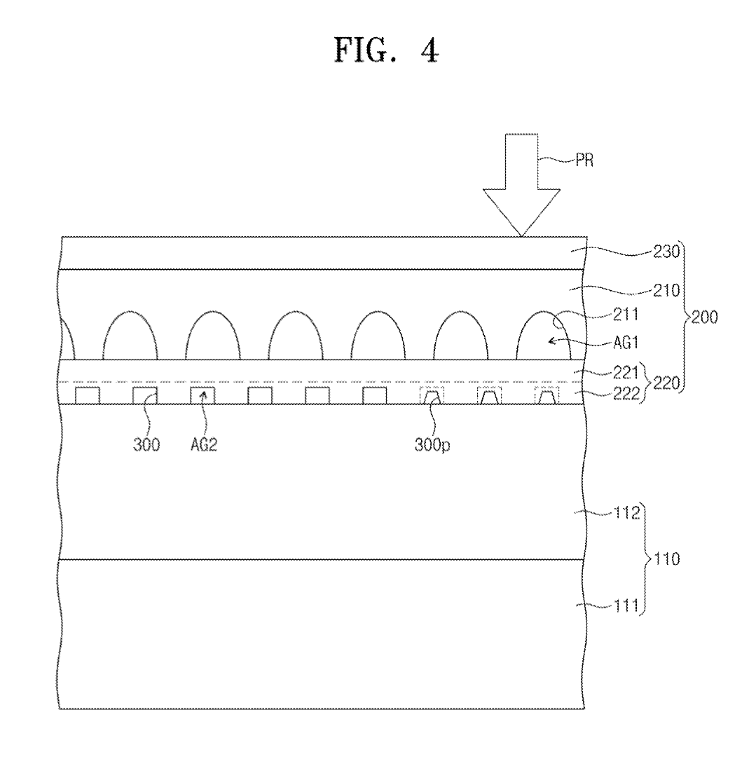

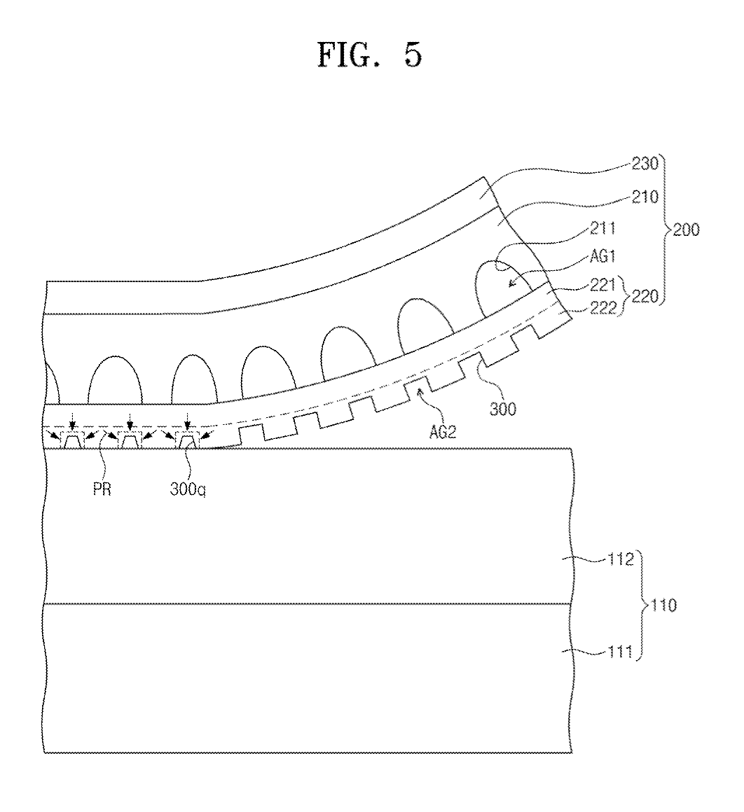

The adhesive layer 220 may be disposed between the refraction layer 210 and the display panel 110. The adhesive layer 220 may include a transparent adhesive resin. The adhesive layer 220 may attach the refraction layer 210 to the display panel 110. The adhesive layer 220 may include the second pattern (300 of FIG. 2) to protect the shape of the first pattern (211 of FIG. 3) by deforming the second pattern (300 of FIG. 2) instead. Detailed description for this will be given with reference to FIGS. 4 and 5.

The cover layer 230 may be a base film. The cover layer 230 may be a transparent film. The cover layer 230 may be composed of other transparent materials not disclosed, but may be a film including polyethylene terephthalate (PET), polycarbonate (PC), and the like.

FIG. 2 is a plan view illustrating one side of the optical film in FIG. 1, and FIG. 3 is a cross-sectional view of the optical film taken along line I-I′ of FIG. 2. In descriptions with reference to FIGS. 2 and 3, like reference numerals are given for like elements described with reference to FIG. 1, and a duplicate descriptions will not be provided.

Referring to FIGS. 2 and 3, the adhesive layer 220 may include a first layer 221 and a second layer 222. The first layer 221 may be disposed between the second layer 222 and the refraction layer 210. The second layer 222 may be disposed between the first layer 221 and the display panel 110. The first layer 221 and the second layer 222 are illustrated as being separated from each other, but the first layer 221 and the second layer 222 may be integrated into a single layer. For example, the first layer 221 and the second layer 222 may substantially include the same material.

The first layer 221 may not be separated from the second layer 222. The first layer 221 may be defined as an area of the adhesive layer 220, in which the second pattern 300 is not formed. According to the present embodiment, the first pattern 211 may be supported by the first layer 221 because the first layer 221 in which the pattern is not formed is disposed below the refraction layer 210 including the first pattern 211.

The second pattern 300 may be defined on the second layer 222. When a surface of the second layer 222, which is attached to the display panel 110, is defined as a first surface SF1, the second pattern 300 may be defined on the first surface SF1. The second pattern 300 may have a groove shape recessed from the first surface SF1. Accordingly, the inside of the second pattern 300 may be filled with air or the like, and a second air gap AG2 may be defined in the second pattern 300.

According to the present embodiment, the second pattern 300 may include a first concave groove 301 and a second concave groove 302. Each of the first concave groove 301 and the second concave groove 302 may be provided in plurality. The first concave groove 301 may extend in a first direction DR1, and the second concave groove 302 may extend in a second direction DR2. The first concave groove 301 and the second concave groove 302 may intersect with each other. The second pattern 300 may have a net-shaped pattern on a plane.

The second layer 222 may be divided into a central area CA defined at the center of a plane and a boundary area SA surrounding the central area CA. According to the present embodiment, the second pattern 300 may be defined in the central area CA.

The second pattern 300 may not be defined in the boundary area SA. Accordingly, an air gap is not formed in the boundary area SA. As a result, air supplied into the second pattern 300 during an attachment process of the optical film 200 may be prevented from being completely discharged to the outside. A detailed description will be provided later.

The refraction layer 210 may include the first pattern 211. When a surface of the refraction layer 210, which is attached to the adhesive layer 220, is defined as a second surface SF2, the first pattern 211 may be defined on the second surface SF2. The first pattern 211 may have a groove shape recessed from the second surface SF2. The first pattern 211 may be filled with air or the like, and a first air gap AG1 may be defined in the first pattern 211.

According to the present embodiment, it is illustrated that the first pattern 211 may have a dot shape on the plane and a cross section thereof may have a rounded U shape, but the inventive concept is not limited thereto. For example, the first pattern 211 may have various shapes such as a prism, a triangular pyramid, and a quadrangular pyramid.

According to the present embodiment, a width 211W of the first pattern 211 may be greater than a width 301W of the second pattern 300. Accordingly, when a pressure is applied, an adhesive power of the adhesive layer 220 may be greater than that of the refraction layer 210 and also a width 301W of the second pattern 300 is less than a width 211W of the first pattern 211. Thus, a shape of the second pattern 300 may be deformed before that of the first pattern 211 is deformed. Accordingly, the shape of the first pattern 211 is designed according to the shape's optical characteristics and the shape of the first pattern 211 may be prevented from being deformed.

FIG. 4 is a state view illustrating a pressure is applied to the optical film in FIG. 3. In the description with reference to FIG. 4, like reference numerals are given for like elements previously explained with reference to FIG. 3, and a duplicate description will not be provided.

Referring to FIG. 4, a pressure PR may be applied to an area of the optical film 200. The pressure PR may occur in various situations such as during a transportation process and/or a manufacturing process.

Unlike this embodiment, when the shape of the first pattern 211 is deformed, a mark of the deformed first pattern 211 may be seen. The deformed first pattern 211 may allow light to be transmitted without refraction, so that the mark of the deformed pattern 211 may be seen. However, according to the embodiment, when the pressure PR is applied, the second pattern 300 may be deformed first before the first pattern 211 is deformed. For example, at least any one of a width and height of the second pattern 300 may become smaller.

In the embodiment, the refraction layer 210 may have a greater hardness than that of the adhesive layer 220. The hardness may provide a magnitude of resistance against deformation when an external force is applied. Accordingly, since the adhesive layer 220 has hardness less than that of the refraction layer 210, the second pattern 300 may be deformed first before the first pattern 211 is deformed by the pressure PR. Accordingly, the first pattern 211 may be prevented from being deformed.

When the second pattern 300 before being pressed is compared with the second pattern 300p after being pressed, the height and width of the pattern are reduced due to the pressure. Since the second pattern 300 is deformed due to the pressure, the first pattern 211 may be prevented from being deformed. As a result, a mark pressed into the optical film 200 or the like may not be seen

FIG. 5 is a state view illustrating the optical film in FIG. 3 being attached to the display panel in FIG. 1. In the description with reference to FIG. 5, like reference numerals are given for like elements previously explained with reference to FIG. 3, and a duplicate description will not be provided.

Referring to FIG. 5, the shape of the second pattern 300 may vary with a pressure applied while the optical film 200 is attached to the display panel 110.

While the optical film 200 is attached to the display panel 110, a pressure may be applied to the optical film 200. The shape of the second pattern 300 may be pressed and deformed while the optical film 200 is attached, and the shape of the first pattern 211 may be prevented from being deformed because the shape of the second pattern 300 has been deformed. Accordingly, a mark resulting from the optical film 200 being applied to the display panel may not be seen.

Since the second pattern 300 is not formed on the boundary area (see reference numeral SA of FIG. 2) when the second pattern 300 is deformed due to a pressure during attachment of the optical film 200, air may be prevented from being completely discharged to the outside. Accordingly, the air may be left inside the second pattern 300 even after the optical film 200 is attached. Resultantly, as illustrated in FIG. 4, the shape of the first pattern 211 may be prevented from being deformed even when a pressure is applied in a state where the optical film 200 is attached to the display panel 110.

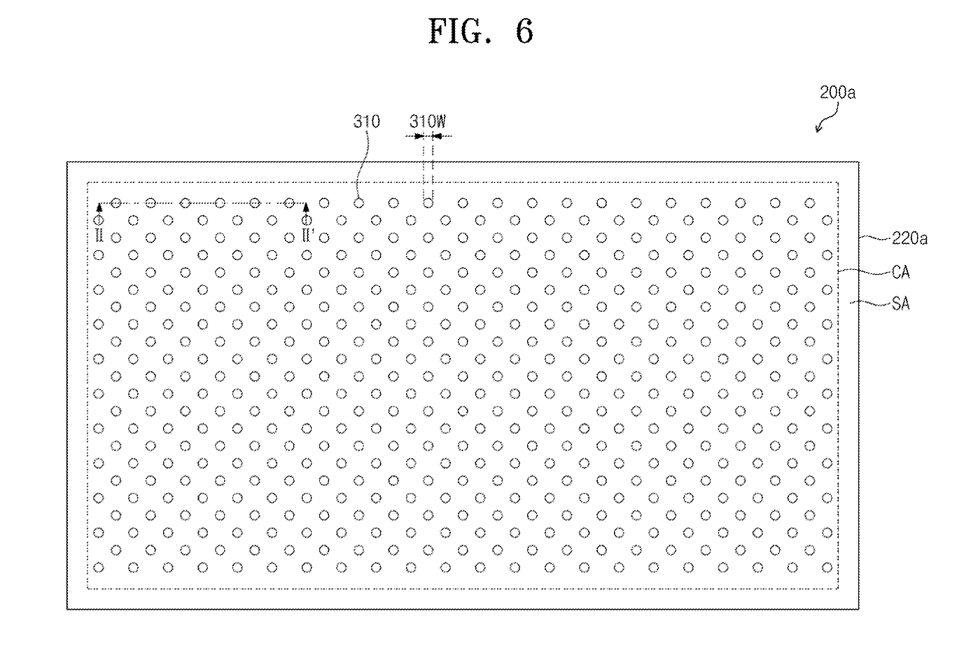

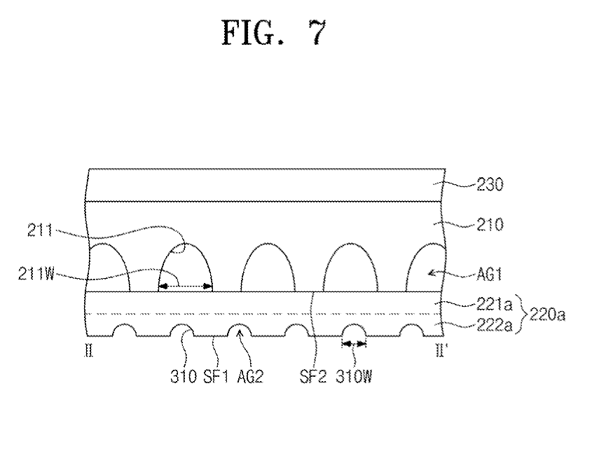

FIG. 6 is a plan view of an optical film according to an embodiment of the inventive concept, and FIG. 7 is a cross-sectional view taken along line II-II′ of FIG. 6. In the description with reference to FIGS. 6 and 7, like reference numerals are given for like elements previously explained with reference to FIG. 3, and a duplicate description will not be provided.

Referring to FIGS. 6 and 7, FIG. 6 may be a plan view illustrating a surface on which the adhesive layer 220a of the optical film 200a is disposed.

The adhesive layer 220a may be divided into a first layer 221a and a second layer 222a, and a second pattern 310 may be defined on the second layer 222a. According to the present embodiment, the second pattern 310 may have a dot shape on a plane.

The second pattern 310 may have a dot shape on the plane and a cross section thereof may have a rounded U shape, but is not limited thereto. For example, the first pattern 211 may have various shapes on a plane such as a polygonal shape including prism, triangular pyramid, and quadrangular pyramid shapes.

According to the present embodiment, the first pattern 211 may have a width 211W greater than a width 310W of the second pattern 310. Accordingly, when a pressure is applied, an adhesive power of the adhesive layer 220 may be greater than that of the refraction layer 210 and a width 310W of the second pattern 310 is smaller than a width 211W of the first pattern 211. Thus, the shape of the second pattern 310 may be more easily deformed than that of the first pattern 211. Accordingly, the first pattern 211 is designed according to the shape's optical characteristics and the shape of the first pattern 211 may be prevented from being deformed.

Also, the refraction layer 210 may have a greater hardness than that of the adhesive layer 220a. The hardness may provide a magnitude of resistance against deformation when an external force is applied. Accordingly, since the hardness of the adhesive layer 220a is smaller than that of the refraction layer 210, the shape of the first pattern may be prevented from being deformed by a pressure.

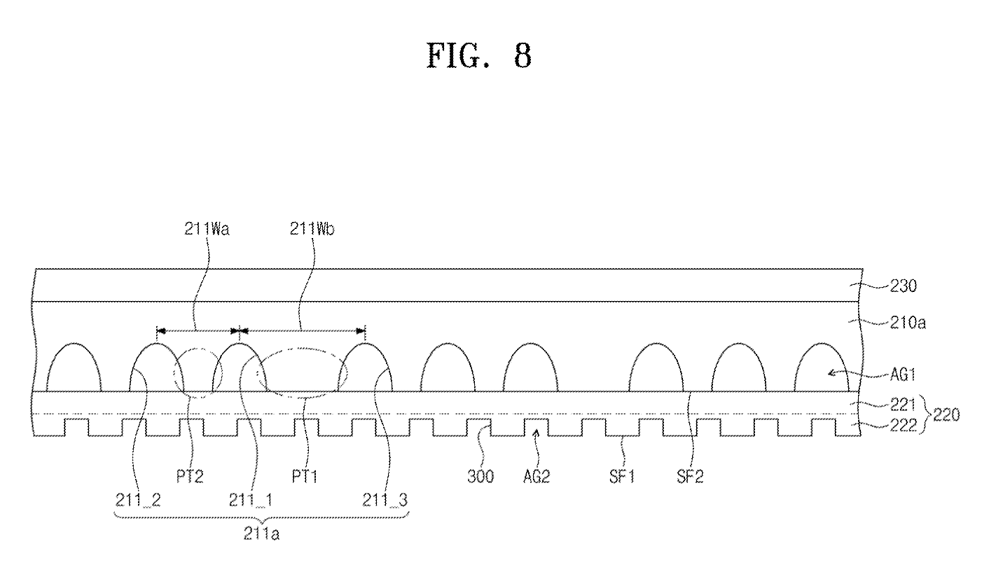

FIG. 8 is a cross-sectional view of an optical film according to an embodiment of the inventive concept. In the description with reference to FIG. 8, like reference numerals are given for like elements explained with reference to FIG. 3, and a duplicate description will not be provided.

Referring to FIG. 8, a distance between first patterns 211a defined in a refraction layer 210a in the embodiment may not be constant. For example, when the first patterns 211a are provided in plurality, one of the first patterns 211a may be defined as a first concave pattern 211_1. The first pattern 211a may include the first concave pattern 211_1, a second concave pattern 211_2 that is adjacent to the first concave pattern 211_1, and a third concave pattern 211_3 that is adjacent to the first concave pattern 211_1. The first concave pattern 211_1 is disposed between the second concave pattern 211_2 and the third concave pattern 211_3.

A distance 211Wb between the first concave pattern 211_1 and the third concave pattern 211_3 may be greater than a distance 211Wa between the first concave pattern 211_1 and the second concave pattern 211_2.

An area PT1 of the refraction layer 210a between the first concave pattern 211_1 and the third concave pattern 211_3 may be greater than an area PT2 of the refraction layer 210a between the first concave pattern 211_1 and the second concave pattern 211_2. Accordingly, when an external pressure is applied, the shape of the first pattern 211a may be more easily prevented from being deformed in the case where a pressure is applied to the area PT1.

The areas PT1 and PT2 may serve as pillars supporting the first pattern 211a, and the area PT2 among the areas of the refraction layer 210a may have a width greater than that of the other area PT1 to easily distribute an external pressure. As a result, the first pattern 211 may be prevented from being deformed.

According to the present embodiment, while the first concave pattern 211_1, the second concave pattern 211_2, and the third concave pattern 211_3 are illustrated with the substantially same width and shape, but are not limited thereto. For example, since distances between the first to third concave patterns 211_1, 211_2, and 211_3 are different, the first to third concave patterns 211_1, 211_2, and 211_3 may also have different shapes to compensate for differences of the distances.

According to the present embodiment, it is illustrated that the second pattern 300 is formed in the adhesive layer 220, but in a different embodiment the second pattern 300 in the adhesive layer 220 may not be provided. In an embodiment of the inventive concept, the second pattern (see reference numeral 310 of FIG. 6) in FIG. 6 may be defined on the adhesive layer 220 instead of the second pattern 300 being formed in the adhesive layer 220.

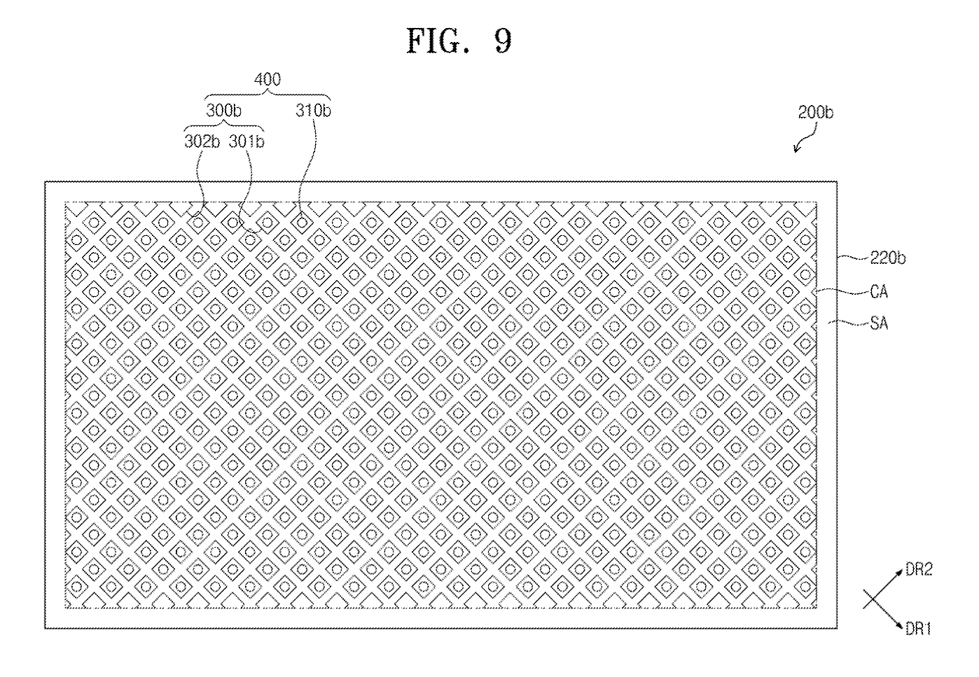

FIG. 9 is a plan view of an optical film according to an embodiment of the inventive concept. In the description with reference to FIG. 9, like reference numerals are given for like elements previously explained with reference to FIG. 2, and a duplicate description will not be provided.

Referring to FIG. 9, an adhesive layer 220b of an optical film 200b is illustrated. The adhesive layer 220b may include a second pattern 400.

According to the present embodiment, the second pattern 400 may include a net pattern 300b and a dot pattern 310b. The net pattern 300b may include a first concave groove 301b extending in a first direction DR1 and a second concave groove 302b extending in a second direction DR2. The dot pattern 310b may have a dot shape on a plane.

According to the present embodiment, it is illustrated that the second pattern 400 may be formed on a central area CA, but is not limited thereto. For example, in an embodiment different from the current embodiment, the second pattern 400 may be formed substantially on an entire surface of the adhesive layer 220b. According to the current embodiment, both the net pattern 300b and the dot pattern 310b may be defined. Accordingly, even when the second pattern 400 is formed substantially on the entire surface of the adhesive layer 220b, air may be prevented from being completely discharged to the outside while the optical film 200b is attached to the display panel (see reference numeral 110 of FIG. 1).

When an external pressure is applied to the optical film 200b, a shape of a first pattern (not shown) formed in a refraction layer (not shown) is prevented from being deformed because the shape of the second pattern 400 is deformed.

Also, light may be refracted and diffused, by a refraction layer (not shown) and the second pattern 400 because the surface of the second pattern 400 and the air gap have a different refractive index. As a result, the second pattern 400 may perform an optical function which is similar to that of the first pattern, and a viewing angle of the display apparatus may be more easily adjusted.

According to an embodiment of the inventive concept, a concave pattern is formed on one surface of the adhesive layer, which is attached to a display panel. When a pressure is applied to an optical film, the concave pattern formed on the surface of the adhesive layer is deformed due to the applied pressure. Accordingly, since the concave pattern formed on the surface of the adhesive layer is deformed due to the pressure, the optical pattern formed on a refraction layer of the optical film may be prevented from being deformed. As a result, a pressed mark or the like on the optical film may not be visible.

Also, the viewing angle of the image that is displayed on the display apparatus by the concave pattern formed on the surface of the adhesive layer and the optical pattern formed on the refraction layer may be extended, resulting in expansion of an area within which a user may watch the image.

Although a preferred embodiment of the inventive concept has been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

What is claimed is:

1. A display apparatus, comprising:
a display panel displaying an image; and
an optical film disposed on the display panel,
wherein the optical film comprises:
a refraction layer comprising a first pattern in which a first air gap is defined; and
an adhesive layer disposed between the refraction layer and the display panel, attaching the refraction layer to the display panel, and comprising first and second layers,
wherein the first layer is disposed between the second layer and the refraction layer, and the second layer is disposed between the first layer and the display panel,
wherein the second layer comprising a second pattern in which a second air gap is defined.

2. The display apparatus of claim 1, wherein a surface of the second layer, which is attached to the display panel, is defined as a first surface, the second pattern is defined on the first surface and has a groove shape recessed from the first surface.

3. The display apparatus of claim 2, wherein the second pattern comprises a first concave groove extending in a first direction and a second concave groove which extends in a second direction crossing the first direction and intersects with the first concave groove.

4. The display apparatus of claim 3, wherein the first pattern has a width greater than that of the second pattern.

5. The display apparatus of claim 2, wherein the second pattern has a dot shape on a plane.

6. The display apparatus of claim 5, wherein the first pattern has a width greater than a diameter of the second pattern.

7. The display apparatus of claim 2, wherein the second pattern comprises a net pattern defined by a first concave groove extending in a first direction and a second concave groove extending in a second direction that intersects with the first direction, and a dot pattern having a dot shape.

8. The display apparatus of claim 2, wherein the second layer comprises a central area defined at the center of a plane and a boundary area surrounding the central area, wherein the second pattern is defined in the central area.

9. The display apparatus of claim 2, wherein the refraction layer has hardness greater than that of the adhesive layer.

10. The display apparatus of claim 2, wherein a surface of the refraction layer, which is attached to the adhesive layer, is defined as a second surface, the first pattern is defined on the second surface and has a groove shape recessed from the second surface.

11. The display apparatus of claim 10, wherein a plurality of first patterns are provided, the plurality of first patterns comprises a first concave pattern, a second concave pattern that is adjacent to the first concave pattern, a third concave pattern that is adjacent to the first concave pattern, wherein the first concave pattern is disposed between the second concave pattern and the third concave pattern, a distance between the first concave pattern and the second concave pattern is greater than a distance between the first concave pattern and the third concave pattern.

12. The display apparatus of claim 1, wherein the optical film further comprises a cover layer disposed on the refraction layer and covering the refraction layer.

13. The display apparatus of claim 1, further comprising a backlight unit disposed below the display panel and providing the display panel with light.

14. A display apparatus, comprising:
a display panel displaying an image; and
an optical film disposed on the display panel,
wherein the optical film comprises:
a refraction layer comprising a plurality of patterns in which air gaps are defined;
an adhesive layer disposed below the refraction layer and attaching the refraction layer to the display panel; and
a cover layer disposed above the refraction layer and covering the refraction layer,
wherein the plurality of patterns comprise a first concave pattern, a second concave pattern that is adjacent to the first concave pattern, a third concave pattern that is adjacent to the first concave pattern,
wherein the first concave pattern is disposed between the second concave pattern and the third concave pattern, a distance between the first concave pattern and the second concave pattern is greater than a distance between the first concave pattern and the third concave pattern.

15. A display apparatus comprising:
a display panel;
a refraction layer including a first pattern including a first cavity; and
an adhesive layer including a second pattern including a second cavity, a top surface and a bottom surface,
wherein the refraction layer and the first pattern have a different refractive index,
wherein the refraction layer is attached to the top surface of the adhesive layer and the display panel is attached to the bottom surface of the adhesive layer, and
wherein the width of the first cavity is greater than the width of the second cavity.

16. The display apparatus of claim 15, wherein the adhesive layer has a greater hardness than the refraction layer.

17. The display apparatus of claim 15, wherein the second pattern comprises a first groove extending in a first direction and a second groove which extends in a second direction crossing the first direction and intersects with the first groove.

18. The display apparatus of claim 15, wherein the second pattern may include a net pattern and a dot pattern,
wherein the net pattern includes a first concave groove extending in a first direction and a second concave groove extending in a second direction, and
wherein the dot pattern has a dot shape.

19. The display apparatus of claim 15, wherein a plurality of first patterns are recessed from a surface of the refraction layer, the plurality of first patterns comprises a first concave pattern, a second concave pattern that is adjacent to the first concave pattern, a third concave pattern that is adjacent to the first concave pattern, wherein the first concave pattern is disposed between the second concave pattern and the third concave pattern, a distance between the first concave pattern and the second concave pattern is greater than a distance between the first concave pattern and the third concave pattern.

20. The display apparatus of claim 15, wherein the first pattern has one of various polygonal shapes, the polygonal shape is one of a prism, triangular pyramid, and quadrangular pyramid shapes.
